(19) United States
(12) Patent Application Publication
(10) Pub. No.: US 2023/0219428 A1
(43) Pub. Date: Jul. 13, 2023

(54) METHOD AND DEVICE FOR CONTROLLING THE CRUISING SPEED OF A HYBRID OR ELECTRIC PROPULSION VEHICLE

(71) Applicant: ZEHUS S.p.A., Milano (IT)

(72) Inventors: Davide FORTE, Milano (IT); Pasquale FORTE, Milano (IT); Paolo LISANTI, Milano (IT)

(21) Appl. No.: 18/011,017

(22) PCT Filed: Jun. 15, 2021
(86) PCT No.: PCT/IB2021/055263

§ 371 Date: Dec. 16, 2022

(30) Foreign Application Priority Data
Jun. 18, 2020 (IT) 102020000014560

(51) Int. Cl. B60L 15/20; B60L 50/20; B62M 6/45

(52) U.S. Cl. CPC B60L 15/2027; B60L 50/20; B62M 6/45; B60L 2200/12; B60L 2240/12; B60L 2240/16

(57) ABSTRACT

A method for controlling the cruising speed of a hybrid or electric propulsion vehicle includes detecting a forward travel speed of the vehicle, identifying a downhill forward travel condition of the vehicle, activating a control of the downhill cruising speed following said identification of said downhill forward travel condition, determining a reference speedy for the vehicle and calculating a charging current for the battery pack generated by the electric motor as a function of a deviation between said reference speed and the detected forward travel speed of the vehicle. The step of identifying a downhill forward travel condition of the vehicle includes calculating a parameter representative of said downhill condition as a function of the detected forward travel speed and the motor current.

The present invention relates to a method and a device for controlling the cruising speed of a hybrid or electric propulsion vehicle, preferably a pedal assist bicycle.

The present invention has particular application in the sustainable mobility sector and, preferably, in the production of low cost hybrid or electric vehicles which are easily affordable for the public at large.

In this regard it should be noted that, in the present text, the term “hybrid” is meant to define a propulsion that entails at least two different energy sources, which in the case of a pedal assist bicycle are defined by an electric motor and the user's muscles.

In recent years, in fact, hybrid or electric propulsion vehicles such as bicycles, kick scooters and scooters are enjoying ever-growing success and popularity, which has changed their product positioning into that of mass consumer goods.

In order to favour the transition towards this segment, however, it has become increasingly necessary for there to be a redesign of propulsion systems that can reduce component costs while not reducing, or indeed improving, the functionalities at the disposal of users.

For the most part, these are vehicles of limited size with batteries sized accordingly; designers in this sector are constantly working to develop control logics that maximise the recovery of energy at moments in which the user does not need assistance from the motor.

For example, different solutions are known today which recover energy by switching the electric machine from an active condition (motor) to a passive condition (generator) in response to some specific commands, such as, for example, backward pushes on the pedal as a replacement for manual braking in pedal assist bicycles,

There are also known solutions, developed by the same Applicant, in which thanks to on-board sensors it is possible to determine when the vehicle is in conditions that are favourable to energy recovery, such as, for example, downhill travel,

These solutions, however, require complex and costly on-board equipment, which is clearly in open contrast with manufacturers' desire to make the products to which the present invention relates—namely e-bikes, electric kick scooters, electric scooters, electric motorbikes and electric minicars—increasingly affordable.

The object of the present invention is therefore to provide a method and a device for controlling the cruising speed of a hybrid or electric propulsion vehicle, preferably a pedal assist bicycle, which overcome the above-mentioned disadvantages of the prior art.

In particular, it is an object of the present invention to provide a method and a device for controlling the cruising speed of a hybrid or electric propulsion vehicle that is high-performing and economical at the same time,

Said object is achieved by a device and a method for controlling the cruising speed of a hybrid or electric propulsion vehicle in accordance with what is contained in the subsequent claims.

In particular, the method according to the invention comprises detecting a parameter representative of a forward travel speed of the vehicle, detecting a (parameter representative of a) current flowing in the electric motor, identifying a downhill forward travel condition of the vehicle, activating a control of the downhill cruising speed following said identification of said downhill forward travel condition, determining a reference speed for the vehicle and calculating a charging current for the battery pack generated by the electric motor as a function of a deviation between said reference speed and the detected forward travel speed of the vehicle.

According to one aspect of the present invention, the step of identifying a downhill forward travel condition of the vehicle comprises calculating a parameter representative of said downhill condition as a function of the forward travel speed of the vehicle and of said current flowing in the electric motor.

Advantageously, this makes it possible to determine whether or not the vehicle is travelling on a downhill stretch without the aid of slope sensors (or such as to enable slope detection) or torque sensors.

Preferably, said parameter representative of said downhill condition is a resistant power resisting the forward travel of the vehicle in the absence of pedalling.

More preferably, the step of identifying the downhill forward travel condition of the vehicle comprises:

calculating the resistant power resisting the forward travel of the vehicle in the absence of pedalling;

determining that the vehicle is travelling downhill when said resistant power has a negative value.

Advantageously, in this manner the slope of the road is determined by making reference solely to the resistant power, a parameter that can be easily calculated with minimal sensor equipment.

The Applicant, in fact, has advantageously found that the resistant power resisting forward travel shows a pattern that is largely similar to that of a road slope, which, as residual contributions in the balance of forces (e.g. wind and friction) can be disregarded, is in fact the parameter of greatest weight in the calculation of resistant power during downhill travel.

In the absence of a contribution from the user (e.g. pedalling), the resistant power can also be calculated without the aid of particular (costly) sensor equipment.

Moreover, this allows the forward travel speed to be limited to a value set/desired by the user, thus minimising the need to activate the mechanical brakes and maximising the energy recovery of the battery pack.

In this regard, preferably, the resistant power comprises at least a first contribution, associated with the power output by the electric motor, and at least a second contribution, associated with the inertias of the vehicle.

More preferably, the resistant power is calculated by means of the following formula:

P_{res_n}=Kₜ·Iₙ·ωₙ−m·aₙ·vₙ

wherein:
P_{res_n} is said resistant power at the present calculation time (n);
Kₜ is the torque constant of the electric motor;
Iₙ is the current flowing in the electric motor at the present calculation time (n);
ωₙ is the rotation speed of the electric motor at the present calculation time (n);
m is the mass of the vehicle, preferably including a user;
aₙ is the acceleration of the vehicle at the present calculation time (n);
vₙ is the forward travel speed of the vehicle detected at the present calculation time (n).

According to a further aspect of the present invention, which is complementary or alternative to the previous one, the method comprises, for every calculation time, at least a step of detecting an acceleration or deceleration command from the user.

This command can be of varying nature, but is preferably to be considered defined by a mechanical action on the user's part, for example, a push of the pedal (forwards or backwards) on a bicycle, an impulsive push on a kick scooter, a mechanical braking, a braking with an e-brake, a remote control or the like,

Preferably, the step of determining the reference speed for the vehicle at the present calculation time (n) comprises:
maintaining the reference speed equal to that of the previous calculation time (n−1) in the absence of acceleration or deceleration commands from the user;
adapting the reference speed to the forward travel speed of the vehicle detected at the present calculation time (n).

Advantageously, in this manner the method allows the user to set the reference value of the cruising speed (downhill), adapting it to his or her needs, for example slowing down in bends and accelerating on straightaways.

The subject matter of the present invention further relates to a device for controlling the cruising speed of a hybrid or electric propulsion vehicle comprising an electric motor and a battery pack.

The device comprises a speed sensor configured to detect the forward travel speed of the vehicle; the sensor could also be inside the vehicle, with the control device configured solely to receive a signal representative of the forward travel speed detected by the sensor.

Furthermore, the device is configured to detect a current flowing in the electric motor (at the same time).

A control unit is configured to determine a reference value for a drive current of the electric motor as a function of said detected forward travel speed.

The control unit preferably comprises an enabling module configured to identify a downhill forward travel condition of the vehicle and to generate an enabling signal following said identification of a downhill forward travel condition.

The control unit preferably further comprises a selection module set up to receive said enabling signal and configured to determine a reference speed for the vehicle.

A controller is preferably configured to calculate a charging current for the battery pack generated by the electric motor as a function of a deviation between said reference speed and the detected forward travel speed of the vehicle.

According to one aspect of the invention, the enabling module is programmed to calculate a parameter representative of said downhill condition as a function of the forward travel speed of the vehicle and of said current flowing in the electric motor.

Advantageously, this makes it possible to determine the whether or not the vehicle is travelling on a downhill stretch without the aid of slope sensors (or such as to enable slope detection) or torque sensors.

Preferably, said parameter representative of said downhill condition is a resistant power resisting the forward travel of the vehicle in the absence of pedalling.

More preferably, the enabling module is programmed to calculate the resistant power resisting the forward travel of the vehicle and to generate said enabling signal when said resistant power has a negative value.

Advantageously, the device according to the invention requires a simple speed sensor (together with the detected current of the electric motor), making it possible to determine a downhill condition and control the respective cruising speed in a simple and economical manner.

Preferably, moreover, the device comprises at least at least a detection element for detecting an acceleration or deceleration command from the user, configured to provide a first command signal, representative of an acceleration given by the user, and/or a second command signal representative of a deceleration given by the user. In this regard it should be noted that said element could also be inside/on-board the vehicle, with the control device configured solely to receive one or more signals representative of said commands.

According to a further aspect of the invention, which is complementary or alternative to the previous ones, the selection module is configured to determine a reference speed for the vehicle at the present calculation time (n) so as to:
maintain the reference speed at the present calculation time (n) equal to that at the previous calculation time (n−1), if, at the present calculation time (n), no first or second command signal is received;
increase the reference speed to a value corresponding to that of the forward travel speed of the vehicle detected by the speed sensor at the present calculation time (n), after said first command signal is received;
reduce the reference speed to a value corresponding to that of the forward travel speed of the vehicle detected by the speed sensor at the present calculation time (n), after said second command signal is received.

Advantageously, thanks to said selection module, the reference speed input to the controller can be adapted to the user's needs so as to define a simple and efficient adaptive cruise control.

It should be noted, in the preferred application thereof, the vehicle is a pedal assist bicycle provided with a pedal assembly and at least a (mechanical or electronic) braking system, wherein the detection element for detecting an acceleration or deceleration command comprises a rotation sensor for sensing a rotation of the pedal assembly and/or an activation sensor for sensing an activation of the braking system.

Preferably, a rotation of said pedal assembly in the same direction as the forward travel of the vehicle defines a first command signal.

Preferably, an activation of said braking system and/or a rotation of said pedal assembly in the opposite direction to the forward travel of the vehicle defines a second command signal.

Advantageously, in this manner the user (a cyclist in this case) has the possibility of adapting the reference value of the cruising speed with simple, intuitive, commonly used commands.

According to a further aspect of the invention, which is complementary or alternative to the previous ones, the device comprises a drive module operatively located downstream of said controller and configured to generate, at the present calculation time, a drive signal for said electric motor representative of:
said charging current, if, at the present calculation time (n), no first or second command signal is received;
a reference current, calculated according to a different control logic, if, at the present calculation time (n), a first command signal and/or a second command signal is detected and/or in the absence of an enabling signal from the enabling module.

Advantageously, this makes it possible to avoid the intervention of the controller, even if enabled, when the user gives manual commands (mechanical and/or digital), thus increasing the safety and reliability of the system.

These and other features, together with the associated advantages, will emerge more dearly from the following illustrative, and hence non-limiting, description of a preferred and thus not exclusive embodiment of a method and a device for controlling the cruising speed of a hybrid or electric propulsion vehicle, preferably a pedal assist bicycle, according to what is illustrated in the appended drawings, in which:

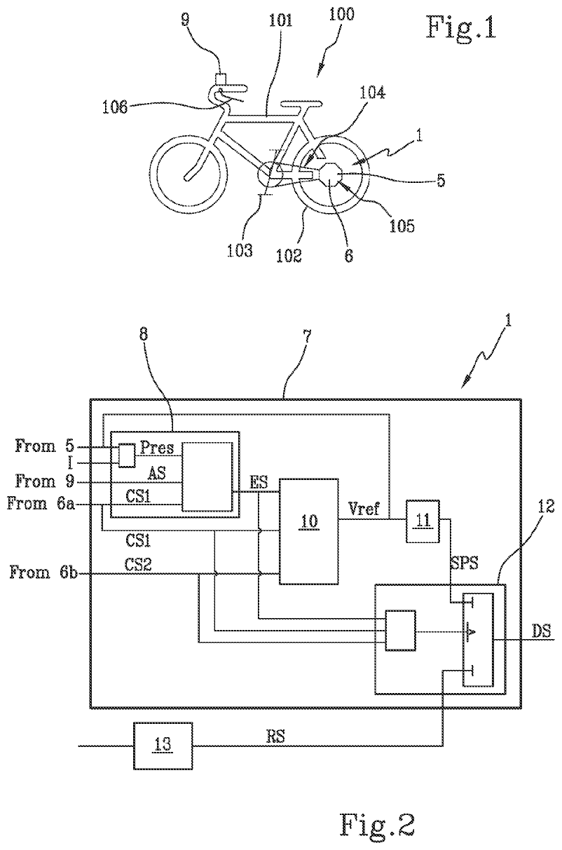

FIG. 1 schematically shows a pedal assist bicycle provided with a control device according to the present invention;

FIG. 2 schematically shows a device for controlling the cruising speed of a hybrid or electric propulsion vehicle, preferably a pedal assist bicycle, according to the present invention.

With reference to the appended figures, the number 1 indicates a device for controlling the cruising speed of a hybrid or electric propulsion vehicle 100.

It should be noted that, in the present text, the expression “hybrid or electric” is meant to define vehicles 100 in which the propulsion is at least partially (preferably only partially) provided by an electric motor 101 powered by a battery pack 103.

In any case, the vehicle 100 comprises both an electric motor 2 and a battery pack 3, connected to each other in order to exchange energy bidirectionally, i.e. from the battery pack to the motor in the assisted (or propulsion) mode and from the motor to the battery pack in the regeneration (or charging) mode,

In the preferred embodiment, the vehicle is a hybrid human/electric propulsion vehicle, such as, for example, a pedal assist bicycle (or e-bike) or an electric kick scooter,

Therefore, the vehicle 100 preferably comprises a frame 101 and at least two wheels 102; in the preferred embodiment, the vehicle further comprises a pedal assembly 103 and a transmission system 104 (preferably a chain drive) for transferring motion from said pedal assembly 103 to one of said wheels 102 (in particular the rear wheel).

Preferably, the presence of a freewheel mechanism 105 is also provided for; the mechanism 105 is operatively interposed between said transmission system 104 and the wheel 102 in order to allow the rotation thereof also in the absence of pedalling.

Preferably, moreover, the vehicle 100 comprises at least a braking system 106 by means of which the user can slow down the rotation speed of one or both wheels 102 and, consequently, the forward travel speed of the vehicle 100.

The control device 1 is thus associated with the electric motor 2 and with the battery pack 3 and is configured to vary the flow of current between the motor 2 and the battery pack 3 according to the operating conditions of the vehicle and/or the user settings.

The control device 1 can thus also be an element other than the motor 2 and the battery pack 3.

However, the control device 1 is preferably a hub motor of the all-in-one type, comprising within it both the electric motor 2 and the battery pack 3.

More precisely, the electric motor 2 and the battery pack 3 are housed in a containment body 4 solidly constrained (or constrainable) to the wheel 102 so as to rotate therewith.

The control device 1 thus comprises a speed sensor 5 configured to detect the forward travel speed of the vehicle 100; the sensor 5 could also be inside/on-board the vehicle 100, with the control device 1 configured solely to receive a signal representative of the forward travel speed detected by the sensor 5.

Preferably, moreover, the control device 1 comprises a detection element 6 for detecting an acceleration or deceleration command from the user, configured to provide a first command signal CS1, representative of an acceleration given by the user, and/or a second command signal CS2, representative of a deceleration given by the user.

In the preferred embodiment, wherein the vehicle 100 is a pedal assist bicycle, said at least one detection element 6 for detecting an acceleration or deceleration command comprising a rotation sensor for sensing a rotation of the pedal assembly 6a and/or an activation sensor 6b for sensing an activation of the braking system.

Preferably, when it detects a rotation of said pedal assembly 103 in the same direction as the forward travel of the vehicle of the vehicle 100, the rotation sensor 6a defines a first command signal CS1.

When it detects a rotation of said pedal assembly 103 in the opposite direction to the forward travel of the vehicle 100, the rotation sensor 6a defines a second command signal CS2.

When it detects an activation of the braking system 106, the activation sensor 6b defines a second command signal CS2,

In the preferred embodiments, the rotation sensor 6a of the pedal assembly 103 is defined by a motion sensor at the bottom bracket or by a motion sensor associated with (i.e. connected to) the rear hub freewheel.

The activation sensor of the braking system, by contrast, is preferably defined by a handlebar switch or, alternatively, by a mechanical lever.

The control device 1 preferably comprises a control unit 7 configured to determine, for each calculation time, a reference value v_{ref_n} for a drive current of the electric motor 2 as a function (at least in part) of the forward travel speed detected by the speed sensor 5.

The control unit 7 preferably comprises an enabling module 8 (or enabler) configured to identify a downhill forward travel condition of the vehicle 100 and to generate an enabling signal ES following said identification of a downhill forward travel condition.

According to one aspect of the invention, the enabling module 8 is programmed to calculate a parameter representative of said downhill condition as a function of the forward travel speed of the vehicle and of said current flowing in the electric motor.

Preferably, said parameter representative of said downhill condition is a resistant power Pᵣₑₛ resisting the forward travel of the vehicle in the absence of pedalling.

More preferably, the enabling module is programmed to calculate a resistant power Pᵣₑₛ resisting the forward travel of the vehicle 100 and to generate said enabling signal ES when said resistant power Pᵣₑₛ has a negative value.

Preferably, the enabling module 8 is configured to calculate the resistant power by adding together a first contribution, associated with the power output by the electric motor 2, and at least a second contribution, associated with the inertias of the vehicle 100.

Advantageously, both the power output by the electric motor 2 and the inertias of the vehicle 100 are known data which do not require any particular sensors in order to be detected and/or estimated, wholly to the advantage of both the cost-effectiveness and reliability of the device 1.

More precisely, the enabling module 8 comprises a computing element configured to calculate said resistant power Pᵣₑₛ as a function of said first and second contributions.

The resistant power at the present calculation time (n) is preferably calculated by means of the following formula:

P_{res_n}=Kₜ·Iₙ·ωₙ−m·aₙ·vₙ

wherein:
P_{res_n}is said resistant power at the present calculation time (n);
Kₜ is the torque constant of the electric motor 2;
Iₙ is the current flowing in the electric motor at the present calculation time (n);
ωₙ is the rotation speed of the electric motor at the present calculation time (n);
m is the mass of the vehicle, preferably including a user;
aₙ is the acceleration of the vehicle at the present calculation time (n);
vₙ is the forward travel speed of the vehicle detected at the present calculation time (n).

It should be noted that the expression “present calculation time” is meant to indicate that, in the control loop, the resistant power at a given time n (present time) is calculated on the basis of values detected at the same calculation time and not on the basis of values detected/calculated at previous times.

Advantageously, in fact, the resistant power thus calculated avoids the need to detect complex parameters, such as the ground slope, while providing an indication closely correlated thereto; the Applicant has in fact found that, in a downhill condition (and in the absence of contributions from the user), there is a substantial correspondence between the ground slope pattern and the resistant power, thus making it possible to identify when the vehicle 100 is in a downhill condition also in the absence of gyroscopes, inertial platforms or satellite maps.

Preferably, moreover, the device 1 comprises a user interface member 9 associable (or associated) with the vehicle 100 and configured to send an activation signal AS to said enabling module 8 following a command given by the user.

The activation signal AS is representative of an activation of a control of the downhill cruising speed of the vehicle, which the user can decide to activate or not to activate by means of the interface member 9.

The enabling module 8 is thus configured to generate said enabling signal ES only after receiving said activation signal AS.

In other words, in the preferred embodiment, the control device 1 is “activated” only when both of the conditions discussed thus far have been satisfied, i.e. the identification of a downhill condition and activation by the user.

Said interface member 9 is preferably a remote control or keypad connected to the control unit 7 of the device 1 by means of a wireless connection channel (e.g. Bluetooth®) and connectable to the vehicle 100, for example to a handlebar or dashboard.

Preferably, moreover, by means of said interface member 9 or by means of a further remote electronic device (e.g. smartphone), the user has the possibility of setting his or her weight in order to make the calculation of the resistant power Pres by the enabling module 8 more accurate.

Alternatively, the enabling module 8 could be pre-set with an average weight value (e.g. 75 kg), which, though less accurate, would make it possible to detect the downhill condition of the vehicle 100.

In a further embodiment, the user's weight could be defined by means of an estimator, which is in itself known and described, for example, in patent application EP3072797 in the name of the same Applicant.

Preferably, moreover, the enabling module 8 is set up to receive said first CS1 and/or second command signal CS2 from the detection element 6 for detecting the acceleration or deceleration command (preferably from the rotation sensor 6a and/or the activation sensor 6b).

The enabling module 8 is preferably configured to generate said enabling signal ES only when said first command signal CS1 and/or second command signal CS2 persists for a time interval or for a number of sampling instants that is less than a pre-established threshold value.

More precisely, therefore, the enabling module 8 is configured to compare the first command signal CS1 or the second command signal CS2, or rather the duration of said signals in terms of time intervals or number of sampling instants, with a pre-established threshold value, and to send the enabling signal AS only when the first command signal CS1 or the second command signal CS2 persist for a time that is less than the threshold value.

In the preferred embodiment, the pre-established threshold value for the first command signal CS1 is greater than 3 seconds, preferably about 5 seconds; in other words, when the user gives an acceleration command to the vehicle for a time interval greater than 3 seconds, the enabling module 8 is precluded from generating the enabling signal ES.

In the preferred embodiment, the enabling module 8 is configured to receive the first command signal CS1 from the rotation sensor 6a of the pedal assembly 103 and to generate the enabling signal ES only when pedalling is detected for a time of less than 5 seconds.

Furthermore, preferably, the enabling module 8 is configured to prevent the generation of said enabling signal ES when said second command signal CS2 (or the signal representative of the detected speed) is representative of a sudden deceleration (e.g., abrupt braking).

In other words, when the entity of the braking is such as to determine a sudden reduction in the forward travel speed, evaluated, for example, by evaluating the derivative of said detected forward travel speed or through said activation sensor 6b of the braking system.

Advantageously, this prevents the control logic from intervening purposelessly when the user decides to govern the vehicle autonomously. Preferably, the enabling module 8 is configured to generate said enabling signal ES only when all of the following conditions occur:
a downhill forward travel condition is identified;
the activation signal AS is received from the interface member 9;
the first command signal CS1 and/or second command signal CS2 persist for a time interval that is less than the threshold value;
there is no sudden braking (determined as a function of the entity/value of the second command signal CS2 or reduction of the detected speed).

If one of these conditions is no longer present, at each sampling instant, the controller will preferably be disabled.

The control unit 7 further comprises a selection module 10 (i.e. a selector) and a controller 11.

The selection module 10 is set up (or configured) to receive said enabling signal AS and configured to determine a reference speed v_{ref} for the vehicle 100.

The controller 11, by contrast, is configured to calculate a charging current for the battery pack 3 generated by the electric motor 2 (in the regeneration mode) as a function of a deviation between said reference speed v_{ref} and the forward travel speed of the vehicle detected by the sensor 5.

The selection module 10 is preferably configured to determine a reference speed v_{ref_n} for the vehicle at the present calculation time (n) so as to, alternatively:
maintain the reference speed v_{ref_n} at the present calculation time (n) equal to the reference speed v_{ref_n-1} of the previous calculation time (n−1), if, at the present calculation time (n), no first command signal CS1 or second command signal CS2 is received;
increase the reference speed to a value corresponding to that of the forward travel speed vₙ, of the vehicle detected by the speed sensor 5 at the present calculation time (n), after said first command signal CS1 is received;
reduce the reference speed to a value corresponding to that of the forward travel speed vₙ of the vehicle detected by the speed sensor 5 at the present calculation time (n), after said second command signal CS2 is received.

Advantageously, in this manner the control is adaptive, capable of adapting to the user's wishes and/or needs.

The controller 11 by contrast, is configured to receive (from the speed sensor 5) a signal representative of the forward travel speed vₙ at the present calculation time (n) and a signal representative of the reference speed V_{ref_n} calculated by the selection module 8.

The controller 11, preferably but not necessarily of a proportional-integral (PI) type, is then configured to calculate a charging current for the battery pack 3 generated by the electric motor 2 (in the regeneration mode) as a function of a deviation between the values of said signals.

The controller 11 is thus configured to generate, as output, a set-point signal SPS representative of said charging current.

Preferably, the device further comprises a drive module 12 (i.e. a driver) operatively located downstream of said controller 11 and configured to generate, at the present calculation time (n), a drive signal DS for said electric motor 2.

The drive signal DS is representative of:
said charging current, if, at the present calculation time (n), no first command signal CS1 or second command signal CS2 is received;
a reference current, calculated according to a different control logic, if, at the present calculation time (n), a first command signal CS1 and/or a second command signal CS2 is detected and/or the enabling signal ES is not generated by the enabling module 7.

In other words, in the absence of actions on the users part, the drive signal DS corresponds to the set-point signal SPS, whereas in the event of a contribution from the user, the controller the drive signal DS corresponds to a reference current calculated according to different control logics, such as, for example, as a function of the forward travel speed and/or of the state of charge of the battery pack.

The drive module 12 preferably comprises a logic element capable of setting the first command signal CS1, the second command signal CS2 and the enabling signal ES on AND, returning:
a first value (e.g. 1) when the first command signal CS1 is null, the second command signal CS2 is null and the enabling signal ES is generated;
a second value when at least one of said conditions does not occur.

The drive module 12 further comprises a switch operatively located downstream of the logic element and configured to generate, as output, a drive signal DS representative of:
said charging current, if the logic element returns said first value;
said reference current, if the logic element returns said second value.

Advantageously, it enables the controller to act directly only in the absence of commands from the user, thus not opposing any accelerations or braking commands given by the user and, on the contrary, assuring the adaptation of the new reference signal to the current conditions.

In this regard, it should be noted that the control unit 7 of the control device 1 preferably comprises a processing unit 13 configured to control the electric motor 2 by generating a reference signal RS representative of a reference current calculated as a function of the forward travel speed of the bicycle vn detected by said speed sensor 5 (as well as the maximum power output, driver temperature and cell voltages).

Preferably, moreover, the reference current is also calculated as a function of a state of charge SOC of the battery pack.

Examples (non-limiting) of such calculation logics are known from the patent publications WO2013124764, WO2018/130982 and EP3276786, some in the name of the same Applicant.

Said reference signal is preferably representative of said reference current as per the drive module 12.

In this regard, in fact, the drive module 12 is operatively located downstream both of the controller 11 and of said processing unit 13 and is configured to generate, at the present calculation time (n), a drive signal DS for said electric motor 2 corresponding to;
said set-point signal SPS if, at the present calculation time (n), no first command signal CS1 or second command signal CS2 is received;
said reference signal RS if, at the present calculation time (n), a first command signal CS1 and/or a second command signal CS2 is detected and/or in the absence of an enabling signal ES from the enabling module 8.

Advantageously, this optimises the operation of the device 1 and the integrability thereof with already existing systems (i.e. retrofitting of the controller).

The subject matter of the present invention further relates to a method for controlling a hybrid or electric propulsion vehicle, preferably, but not exclusively, implementable by means of the control device described thus far.

The method comprises detecting, first of all, a forward travel speed of the vehicle 100 and identifying a downhill forward travel condition of the vehicle 100.

That being said, all of the features mentioned and described in relation to the device, where not expressly specified or in the event of incompatibility, are to be considered applicable mutatis mutandis to the following description of the method of the present invention.

Preferably, the step of detecting the downhill forward travel condition comprises calculating a parameter representative of said downhill condition as a function of the forward travel speed of the vehicle and said current flowing in the electric motor.

Advantageously, this makes it possible to determine whether or not the vehicle is travelling on a downhill stretch without the aid of slope sensors (or such as to enable slope detection) or torque sensors.

Said parameter representative of said downhill condition is preferably a resistant power Pᵣₑₛ resisting the forward travel of the vehicle in the absence of pedalling.

More preferably, the step of identifying the downhill forward travel condition of the vehicle comprises calculating the resistant power Pᵣₑₛ resisting the forward travel of the vehicle 100 and determining that the vehicle is travelling downhill when said resistant power Pᵣₑₛ has a negative value.

The resistant power Pᵣₑₛ is preferably calculated by adding together a first contribution, associated with the power output by the electric motor 2, and at least a second contribution, associated with the inertias of the vehicle 100.

Advantageously, both the power output by the electric motor 2 and the inertias of the vehicle 100 are known data, which do not require any particular sensors in order to be detected and/or estimated, wholly to the advantage of both the cost-effectiveness and reliability of the device 1.

In this regard, in addition to the forward travel speed, the current flowing in the electric motor 2 is also preferably detected.

More preferably, the resistant power at the present calculation time (n) is calculated by means of the following formula:

P_{res_n}=Kₜ·Iₙ·ωₙ−m·aₙ·vₙ

wherein:
P_{res_n} is said resistant power at the present calculation time (n);
Kₜ is the torque constant of the electric motor 2;
Iₙ is the current flowing in the electric motor at the present calculation time (n);
wₙ is the rotation speed of the electric motor at the present calculation time (n);
m is the mass of the vehicle, preferably including a user;
aₙ is the acceleration of the vehicle at the present calculation time (n);
   vₙ is the forward travel speed of the vehicle detected at the present calculation time (n).

It should be noted that the expression “present calculation time” is meant to indicate that, in the control loop, the resistant power at a given time n (present time) is calculated on the basis of values detected at the same calculation time and not on the basis of values detected/calculated at previous times.

The method preferably comprises activating a control of the downhill cruising speed following said identification of said downhill forward travel condition.

Advantageously, in this manner it is possible to activate a cruise control dedicated to downhill travel, an optimal moment for charging the battery pack 3 of the vehicle 100.

Preferably, moreover, the method comprises activating the control of the downhill cruising speed only in the absence of a contribution from the user in terms of acceleration and/or braking (deceleration).

In particular, the control of the downhill cruising speed is activated only when the user provides no contribution in terms of acceleration and/or braking, or when he or she provides a limited contribution, for example of a duration less than a pre-established threshold value.

In this regard, therefore, at least a step of detecting an acceleration or deceleration command from the user is provided for.

In the preferred embodiment, wherein the vehicle is a pedal assist bicycle provided with a pedal assembly 103 and/or a braking system 106.

Therefore, the acceleration or deceleration commands from the user comprise one or more of the following commands:
a rotation of said pedal assembly 103 in the same direction as the forward travel, defining an acceleration command;
a rotation of said pedal assembly 103 in the opposite direction to the forward travel, defining a deceleration command;
an activation of said braking system 106, defining a deceleration command.

Following the activation of the control, a reference speed is determined for the vehicle 100.

In this regard, the step of determining the reference speed v_{ref} for the vehicle at the present calculation time (n) preferably comprises:
maintaining the reference speed v_{ref} at the present calculation time (n) equal to that of the previous calculation time (n−1), in the absence of acceleration or deceleration commands from the user;
adapting the reference speed v_{ref} at the present calculation time (n) to the forward travel speed of the vehicle detected at the present calculation time (n).

It should be noted that, in the present text, the expression “the previous calculation time” is meant to define a calculation time preceding the present one, preferably, but not necessarily, the immediately preceding one.

Advantageously, thanks to this succession of steps it is possible to implement an adaptive control of the cruising speed.

More precisely, the user can modify the reference speed v_{ref} at his or her initiative on the basis of personal needs or the route, or else with the aim of maximising the charging of the battery pack 3, with simple, intuitive commands such as, for example, pushes on the pedal (forwards or backwards) or braking.

At this point, it is envisaged to calculate a charging current for the battery pack 3 generated by the electric motor 2 as a function of a deviation between said reference speed v_{ref} and the detected forward travel speed of the vehicle

The calculation is preferably performed by means of a proportional-integral (PI) control system and the associated transfer functions, but it could also be performed by means of a control system of another nature.

At this point, finally, a reference value is determined (for each calculation time) for the drive current of the electric motor.

The following are alternatively assigned to said drive current:
the value of the calculated charging current, in the absence of acceleration or deceleration commands from the user;
a current value calculated according to a different control logic (for example as a function of the forward travel speed and/or the state of charge of the battery pack), when an acceleration or deceleration command from the user is detected.

Advantageously, this allows a variable command to be given to the electric motor by activating or not activating the speed control depending on the presence or absence of a user command.

The invention achieves the stated objects and brings important advantages.

In fact, the presence of a control system provided with an enabling module capable of identifying downhill travel in the absence of dedicated sensors renders the vehicle high-performing and at the same time economical to produce, wholly to the advantage of the manufacturer and/or purchaser.

Moreover, the presence of a controller which sets the charging current with the aim of maintaining the reference cruising speed helps to maximise the recovery of energy during downhill travel.

Furthermore, the use of a selection module capable of varying or not varying the reference speed on the basis of a command given by the user maximises the efficiency of the device.

1. A method for controlling the cruising speed of a hybrid or electric propulsion vehicle comprising an electric motor and a battery pack, said method comprising the steps of:
detecting a parameter representative of a forward travel speed of the vehicle;
identifying a downhill forward travel condition of the vehicle;
activating a control of the downhill cruising speed following said identification of said downhill forward travel condition;
determining a reference speed for the vehicle;
calculating a charging current for the battery pack generated by the electric motor as a function of a deviation between said reference speed and the detected forward travel speed of the vehicle,
wherein said step of identifying a downhill forward travel condition of the vehicle comprises calculating a parameter representative of said downhill forward travel condition as a function of the forward travel speed of the vehicle and of said current flowing in the electric motor.

2. The method according to claim 1, wherein said parameter representative of said downhill forward travel condition comprises a resistant power resisting the forward travel of the vehicle.

3. The method according to claim 2, wherein said step of identifying a downhill forward travel condition of the vehicle comprises:
calculating the resistant power resisting the forward travel of the vehicle;
determining that the vehicle is travelling downhill when said resistant power has a negative value.

4. The method according to claim 3, wherein said resistant power comprises at least a first contribution, associated with the power output by the electric motor, and at least a second contribution, associated with the inertias of the vehicle.

5. The method according to claim 2, wherein said resistant power is calculated by means of the following formula:
P_{res_n}=Kₜ·Iₙ·ωₙ−m·aₙ·vₙ
wherein:
P_{res_n} is said resistant power at the present calculation time;
Kₜ is the torque constant of the electric motor;
Iₙ is the current flowing in the electric motor at the present calculation time;
ωₙ is the rotation speed of the electric motor at the present calculation time;
m is the mass of the vehicle, preferably including a user;
aₙ is the acceleration of the vehicle at the present calculation time;
vₙ is the forward travel speed of the vehicle detected at the present calculation time.

6. The method according to claim 1, comprising, for every calculation time, at least a step of detecting an acceleration or deceleration command from the user, wherein said step of determining a reference speed for the vehicle at the present calculation time comprises:
maintaining the reference speed at the present calculation time equal to that of the previous calculation time, in the absence of acceleration or deceleration commands from the user;
adapting the reference speed to the forward travel speed of the vehicle detected at the present calculation time.

7. The method according to claim 1, comprising, for every calculation time, at least:
a step of detecting an acceleration or deceleration command from the user,
a step of determining a present value for the drive current of the electric motor, wherein said determining step comprises assigning to said present value, alternatively:
the value of the calculated charging current, in the absence of acceleration or deceleration commands from the user;
a current value calculated according to a different control logic when an acceleration or deceleration command from the user is detected.

8. The method according to claim 6, wherein said vehicle is a pedal assist bicycle provided with a pedal assembly and at least a braking system; said acceleration or deceleration commands from the user comprising one or more of the following commands:
a rotation of said pedal assembly in the same direction as the forward travel, defining an acceleration command;
a rotation of said pedal assembly in the opposite direction to the forward travel, defining a deceleration command;
an activation of said braking system, defining a deceleration command.

9. A device for controlling the cruising speed of a hybrid or electric propulsion vehicle comprising an electric motor and a battery pack, said device comprising:
a speed sensor configured to detect the forward travel speed of the vehicle;
a control unit configured to determine a reference value for a drive current of the electric motor as a function of said detected forward travel speed, wherein said control unit comprises:
an enabling module configured to identify a downhill forward travel condition of the vehicle and to generate an enabling signal following said identification of a downhill forward travel condition;
a selection module set up to receive said enabling signal and configured to determine a reference speed for the vehicle;
a controller configured to calculate a charging current for the battery pack generated by the electric motor as a function of a deviation between said reference speed and the detected forward travel speed of the vehicle and to generate, as output, a set-point signal representative of said charging current,
wherein said enabling module is configured to calculate a parameter representative of said downhill forward travel condition as a function of the forward travel speed of the vehicle and of said current flowing in the electric motor.

10. The device according to claim 9, wherein the enabling module is programmed to calculate a resistant power resisting the forward travel of the vehicle and to generate said enabling signal when said resistant power has a negative value.

11. The device according to claim 10, wherein said enabling module of the control unit is configured to calculate said resistant power by adding together a first contribution, associated with the power output by the electric motor, and at least a second contribution, associated with the inertias of the vehicle.

12. The device according to claim 10, wherein said resistant power at the present calculation time is calculated by means of the following formula:
P_{res_n}=Kₜ·Iₙ·ωₙ−m·aₙ·vₙ
wherein:
P_{res_n} is said resistant power at the present calculation time;
Kₜ is the torque constant of the electric motor;
Iₙ is the current flowing in the electric motor at the present calculation time;
ωₙ is the rotation speed of the electric motor at the present calculation time;
m is the mass of the vehicle, preferably including a user;
aₙ is the acceleration of the vehicle at the present calculation time;
vₙ is the forward travel speed of the vehicle detected at the present calculation time.

13. The device according to claim 9, comprising a user interface member associable with the vehicle and configured to send to said enabling module, following a command given by the user, an activation signal representative of an activation of a control of the downhill cruising speed of the vehicle; said enabling module being configured to generate said enabling signal only after receiving said activation signal.

14. The device according to claim 9, comprising at least a detection element for detecting an acceleration or deceleration command from the user, configured to provide a first command signal, representative of an acceleration given by the user, and/or a second command signal, representative of a deceleration given by the user.

15. The device according to claim 14, wherein said enabling module is set up to receive said first and/or second command signal and to generate said enabling signal only if said first and/or second command signal persists for a time interval or for a number of sampling instants that is less than a pre-established threshold value.

16. The device according to claim 14, wherein the enabling module is configured to prevent the generation of said enabling signal when said second command signal is representative of a sudden deceleration.

17. The device according to claim 13, wherein said selection module is configured to determine a reference speed for the vehicle at the present calculation time so as to:
maintain the reference speed at the present calculation time equal to that at the previous calculation timed, if, at the present calculation time, no first or second command signal is received;
increase the reference speed at the present calculation time to a value corresponding to that of the forward travel speed of the vehicle detected by the speed sensor at the present calculation time, after said first command signal is received;
reduce the reference speed at the present calculation time to a value corresponding to that of the forward travel speed of the vehicle detected by the speed sensor at the present calculation time, after said second command signal is received.

18. The device according to claim 13, wherein said vehicle is a pedal assist bicycle provided with a pedal assembly and at least a braking system; said at least one detection element for detecting an acceleration or deceleration command comprising a rotation sensor for sensing a rotation of the pedal assembly and/or an activation sensor for sensing an activation of said braking system, wherein:
a rotation of said pedal assembly in the same direction as the forward travel of the vehicle defines a first command signal;
an activation of said braking system and/or a rotation of said pedal assembly in the opposite direction to the forward travel of the vehicle defines a second command signal.

19. The device according to claim 13, comprising a drive module operatively located downstream of said controller and configured to generate, at the present calculation time, a drive signal for said electric motor representative of:
said charging current, if, at the present calculation time, no first or second command signal is received;
a reference current, calculated according to a different control logic, if at the present calculation time a first command signal and/or a second command signal is detected and/or in the absence of an enabling signal from the enabling module.

20. A pedal assist bicycle comprising:
a frame;
at least one wheel;
an electric motor associated with said at least one wheel,
at least one battery pack associated with said motor in order to exchange energy therewith bidirectionally;
a pedal assembly;
a transmission operatively interposed between said pedal assembly and said at least one wheel
a freewheel mechanism associated with said at least one wheel;
a control device according to claim 1.

21. The pedal assist bicycle according to claim 20, wherein said control unit of the control device comprises a processing unit configured to drive the electric motor by generating a reference signal representative of a reference current calculated as a function of the forward travel speed of the bicycle detected by said speed sensor; said control unit of the control device comprising a drive module:
operatively located downstream of said controller and of said processing unit and
configured to generate, at the present calculation time, a drive signal for said electric motor corresponding to:
said set-point signal, if, at the present calculation time, no first or second command signal is received;
said reference signal, if, at the present calculation time, a first command signal and/or a second command signal is received and/or in the absence of an enabling signal from the enabling module.

22. A non-transitory storage medium readable by a computer having a program comprising software code portions adapted to carry out the identifying, activating, determining and calculating steps of the method according to claim 1, when said program is run on at least one computer.
